(19) United States
(12) Patent Application Publication
(10) Pub. No.: US 2025/0081173 A1
(43) Pub. Date: Mar. 6, 2025

(54) INDICATING INFORMATION OF BAND COMBINATIONS

(71) Applicant: Nokia Technologies Oy, Espoo (FI)

(72) Inventors: Hiromasa UMEDA, Tokyo (JP); Petri Juhani VASENKARI, Espoo (FI); Tero HENTTONEN, Espoo (FI)

(21) Appl. No.: 18/727,639

(22) PCT Filed: Dec. 7, 2022
(86) PCT No.: PCT/FI2022/050810

§ 371 Date: Jul. 9, 2024

Related U.S. Application Data
(60) Provisional application No. 63/299,485, filed on Jan. 14, 2022.

(51) Int. Cl. H04W 72/0453; H04L 5/00; H04W 8/24; H04W 72/51; H04W 88/06

(52) U.S. Cl. CPC H04W 72/0453; H04L 5/001; H04W 8/24; H04W 72/51; H04W 88/06

(57) ABSTRACT

There is provided a method comprising: determining (300) a plurality of band combinations supported by the apparatus for aggregating multiple carriers, each band combination comprising at least two bands; identifying (302), among the plurality of supported band combinations, a first band combination wherein the first band combination is a subset of one or more of the supported band combinations and wherein, for the first band combination, the apparatus supports a low maximum sensitivity degradation (MSD) which is lower than a predetermined MSD value; and transmitting (304) to a network an indication of the identified first band combination and low MSD information associated with the identified first band combination, wherein the low MSD information is valid also for each of the supported band combinations which comprises at least the bands of the first band combination.

### TECHNICAL FIELD

Various example embodiments relate generally to indication of information related to band combinations having low maximum sensitivity degradation (MSD).

### BACKGROUND

As part of user equipment (UE) capability signaling, the UE may transmit information related to supported band combinations. Different band combinations may be associated with different maximum sensitivity degradations (MSDs). These MSD requirements for different band combinations may be defined by 3GPP, for example. Large MSD values may render the band configuration/combination useless for deployment. This is because even if network configures a UE with the band configuration, the UE may or may not receive the downlink (DL) signal on the combined DL band correctly due to the large MSD. This causes waste of time and frequency resources.

It is further noted that 3GPP requirements for MSD are minimum requirements so that there are UEs with low MSD or even zero MSD. However, even if there are UEs with small or non-existing MSD values, these UEs are currently treated in the same manner as other UEs with larger MSD. This may decrease UE vendors' motivation to develop UEs with better performance than 3GPP requirements, as the network may be unable to make maximum use of the UEs with lower MSD, in case the network cannot differentiate UE with lower and larger MSDs.

Therefore, there may be a need to introduce a capability signaling to distinguish between UEs with lower MSD and UEs with larger MSD. How to do this in resource efficient manner is unclear.

### BRIEF DESCRIPTION

According to some aspects, there is provided the subject matter of the independent claims. Some further aspects are defined in the dependent claims. The embodiments that do not fall under the scope of the claims are to be interpreted as examples useful for understanding the disclosure.

### LIST OF THE DRAWINGS

In the following, the invention will be described in greater detail with reference to the embodiments and the accompanying drawings, in which

FIG. 1 presents a network, according to an embodiment;

FIGS. 2A-2C show some aspects of MSD and band combinations, according to some embodiments;

FIG. 3 shows a method, according to an embodiment;

FIG. 4 illustrates relationship between fallback band combinations and parent band combinations, according to an embodiment;

FIG. 5 shows a signaling flow diagram, according to an embodiment;

FIG. 6 illustrate a method, according to an embodiment;

FIGS. 7A and 7C show some embodiments for signaling low MSD information; and

FIGS. 8 and 9 illustrate apparatuses, according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a radio system, such as one comprising at least one of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE). Term ‘eLTE’ here denotes the LTE evolution that connects to a 5G core. LTE is also known as evolved UMTS terrestrial radio access (EUTRA) or as evolved UMTS terrestrial radio access network (EUTRAN). A term “resource” may refer to radio resources, such as a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources

The embodiments are not, however, restricted to the systems/RATs given as an example but a person skilled in the art may apply the solution to other communication systems provided with necessary properties. One example of a suitable communications system is the 5G system. The 3GPP solution to 5G is referred to as New Radio (NR). 5G has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customised to meet the specific needs of applications, services, devices, customers or operators.

In radio communications, node operations may in be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of labour between core network operations and base station operations may vary depending on implementation. Thus, 5G networks architecture may be based on a so-called CU-DU split. One gNB-CU controls several gNB-DUs. The term ‘gNB’ may correspond in 5G to the eNB in LTE. The gNBs (one or more) may communicate with one or more UEs. The gNB-CU (central node) may control a plurality of spatially separated gNB-DUs, acting at least as transmit/receive (Tx/Rx) nodes. In some embodiments, however, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI model and the functionalities within each layer.

In an embodiment, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Some other technology advancements probably to be used are Software-Defined Networking (SDN), Big Data, and all-IP, to mention only a few non-limiting examples. For example, network slicing may be a form of virtual network architecture using the same principles behind software defined networking (SDN) and network functions virtualisation (NFV) in fixed networks. SDN and NFV may deliver greater network flexibility by allowing traditional network architectures to be partitioned into virtual elements that can be linked (also through software). Network slicing allows multiple virtual networks to be created on top of a common shared physical infrastructure. The virtual networks are then customised to meet the specific needs of applications, services, devices, customers or operators.

The plurality of gNBs (access points/nodes), each comprising the CU and one or more DUs, may be connected to each other via the Xn interface over which the gNBs may negotiate. The gNBs may also be connected over next generation (NG) interfaces to a 5G core network (5GC), which may be a 5G equivalent for the core network of LTE. Such 5G CU-DU split architecture may be implemented using cloud/server so that the CU having higher layers locates in the cloud and the DU is closer to or comprises actual radio and antenna unit. There are similar plans ongoing for LTE/LTE-A/eLTE as well. When both eLTE and 5G will use similar architecture in a same cloud hardware (HW), the next step may be to combine software (SW) so that one common SW controls both radio access networks/technologies (RAN/RAT). This may allow then new ways to control radio resources of both RANs. Furthermore, it may be possible to have configurations where the full protocol stack is controlled by the same HW and handled by the same radio unit as the CU.

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future rail-way/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The embodiments may be also applicable to narrow-band (NB) Internet-of-things (IoT) systems which may enable a wide range of devices and services to be connected using cellular telecommunications bands. NB-IoT is a narrowband radio technology designed for the Internet of Things (IoT) and is one of technologies standardized by the 3rd Generation Partnership Project (3GPP). Other 3GPP IoT technologies also suitable to implement the embodiments include machine type communication (MTC) and eMTC (enhanced Machine-Type Communication). NB-IoT focuses specifically on low cost, long battery life, and enabling a large number of connected devices. The NB-IoT technology is deployed “in-band” in spectrum allocated to Long Term Evolution (LTE)—using resource blocks within a normal LTE carrier, or in the unused resource blocks within a LTE carrier's guard-band- or “standalone” for deployments in dedicated spectrum.

The embodiments may be also applicable to device-to-device (D2D), machine-to-machine, peer-to-peer (P2P) communications. The embodiments may be also applicable to vehicle-to-vehicle (V2V), vehicle-to-infrastructure (V2I), infrastructure-to-vehicle (I2V), or in general to V2X or X2V communications.

FIG. 1 illustrates an example of a communication system to which embodiments of the invention may be applied. The system may comprise a control node 110 providing one or more cells, such as cell 100, and a control node 112 providing one or more other cells, such as cell 102. Each cell may be, e.g., a macro cell, a micro cell, femto, or a pico cell, for example. In another point of view, the cell may define a coverage area or a service area of the corresponding access node. The control node 110, 112 may be an evolved Node B (eNB) as in the LTE and LTE-A, ng-eNB as in eLTE, gNB of 5G, or any other apparatus capable of controlling radio communication and managing radio resources within a cell. The control node 110, 112 may be called a base station, network node, or an access node.

The system may be a cellular communication system composed of a radio access network of access nodes, each controlling a respective cell or cells. The access node 110 may provide user equipment (UE) 120 (one or more UEs) with wireless access to other networks such as the Internet. The wireless access may comprise downlink (DL) communication from the control node to the UE 120 and uplink (UL) communication from the UE 120 to the control node.

Additionally, although not shown, one or more local area access nodes may be arranged such that a cell provided by the local area access node at least partially overlaps the cell of the access node 110 and/or 112. The local area access node may provide wireless access within a sub-cell. Examples of the sub-cell may include a micro, pico and/or femto cell. Typically, the sub-cell provides a hot spot within a macro cell. The operation of the local area access node may be controlled by an access node under whose control area the sub-cell is provided. In general, the control node for the small cell may be likewise called a base station, network node, or an access node.

There may be a plurality of UEs 120, 122 in the system. Each of them may be served by the same or by different control nodes 110, 112. The UEs 120, 122 may communicate with each other, in case D2D communication interface is established between them.

The term “terminal device” or “UE” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the case of multiple access nodes in the communication network, the access nodes may be connected to each other with an interface. LTE specifications call such an interface as X2 interface. For IEEE 802.11 network (i.e. wireless local area network, WLAN, WiFi), a similar interface Xw may be provided between access points. An interface between an eLTE access point and a 5G access point, or between two 5G access points may be called Xn. Other communication methods between the access nodes may also be possible. The access nodes 110 and 112 may be further connected via another interface to a core network 116 of the cellular communication system. The LTE specifications specify the core network as an evolved packet core (EPC), and the core network may comprise a mobility management entity (MME) and a gateway node. The MME may handle mobility of terminal devices in a tracking area encompassing a plurality of cells and handle signaling connections between the terminal devices and the core network. The gateway node may handle data routing in the core network and to/from the terminal devices. The 5G specifications specify the core network as a 5G core (5GC), and there the core network may comprise e.g. an access and mobility management function (AMF) and a user plane function/gateway (UPF), to mention only a few. The AMF may handle termination of non-access stratum (NAS) signaling, NAS ciphering & integrity protection, registration management, connection management, mobility management, access authentication and authorization, security context management. The UPF node may support packet routing & forwarding, packet inspection and QoS handling, for example.

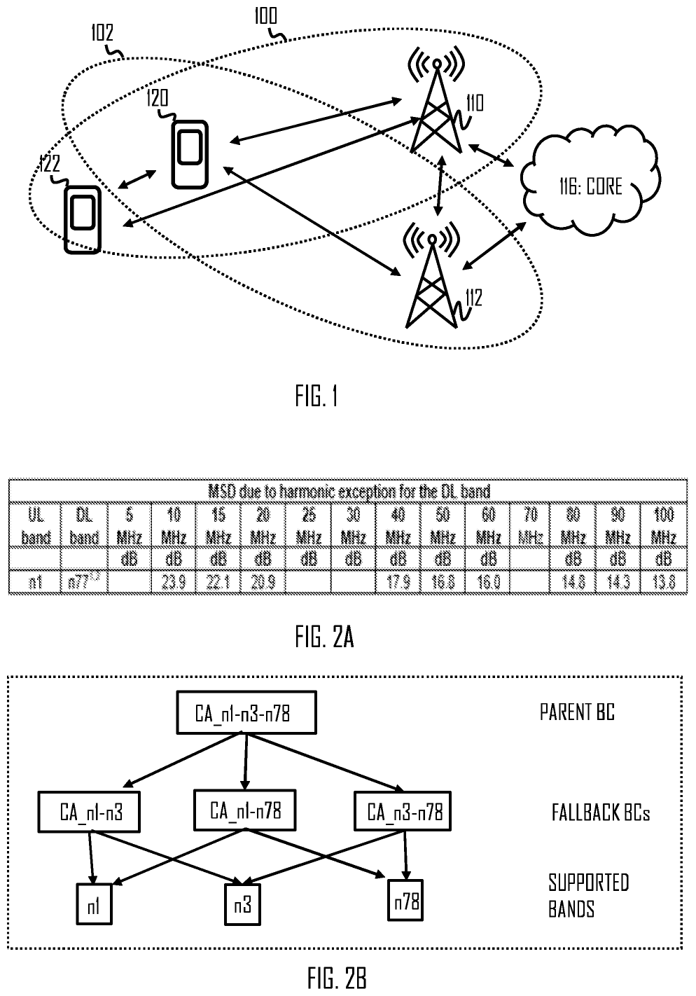

MSD is an indicator of maximum sensitivity degradation for radio frequency (RF) receiver reference sensitivity for carrier aggregation (CA) or multi radio dual connectivity, in general for aggregating multiple carriers. In technical specifications, in case a CA or DC configuration (also known as a band combination) has MSD, there may be some relaxations for reference sensitivity by the amount of MSD are allowed. This means that the noise level for the carrier is increased, which reduces UE performance (as more power is required to reach higher signal-to-noise ratio. For example, FIG. 2A shows an example table from technical specifications depicting MSD due to harmonic exception for the DL band in a band combination comprising an UL band of n1 and a DL band of n77. As can be seen, the table indicates that when CA_n1-n77 is configured, 23.9 dB reference sensitivity degradation is allowed for 10 MHz channel bandwidth for n77 (under a certain frequency conditions). It should be noted that 10 MHz carrier BW reference sensitivity for n77 single band operation is −95.3 dBm. More specifically the table means that when a reference sensitivity for n77 for CA_n1-n77 operation is tested, the UE can pass the requirement with the wanted signal power level of −71.4 dBm (−95.3 dBm+23.9 dB).

The use of “band” is used throughout to refer to different cells for aggregating carriers, such as to different serving cells for uplink CA. This is intended to cover both the use of different cells under different bands (inter-band CA) as well as different cells under the same band (intra-band CA). In an embodiment, band combination may thus be replaced with cell combination or carrier combination.

Since different UEs may perform better than what is specified by the minimum requirements of the 3GPP, there may be a need to differentiate UEs with lower MSDs from UEs with larger MSDs, so as to allow the UEs and the network to utilize the capabilities of the UEs more efficiently. One of the foreseeable problems is that signaling overhead may increase.

Current signaling structures assume that each fallback band combination supports at least the same capabilities as those for the parent band combination unless explicitly indicated otherwise (e.g. UE indicating capabilities separately for a fallback band combination). For example, if UE supports some capabilities for CA_n1-n3-n78-nX, the UE shall also support those same capabilities for fallback band combinations like CA_n1-n3-n78, CA_n1-n3-nX, CA_n3-n78-nX and CA_n1-n3, etc. As an example, FIG. 2B shows fallback band combinations (FB BCs) when the parent band combination (P BC) is n1-n3-n78. In general, a fallback band combination is a subset of bands of the respective parent band combination. I.e. a fallback band combination can be obtained from a respective parent band combination by releasing one or more cells (which may also mean that the entire band is released from the band combination, as is exemplified here).

The MSD requirements, however, are different and unique compared to the other requirements and there are no MSD requirements for band combinations whose number of UL bands is >2 and that of DL bands is >3. More specifically, the MSD requirements may be classified e.g. as follows:
#UL Bands=1, #DL bands=2→Root cause of MSD=Harmonics
#UL Bands=1, #DL bands=2→Root cause of MSD=Harmonics Mixing.
UL Bands=1, #DL bands=2→Root cause of MSD=Cross band isolation.
UL Bands=2, #DL bands=2→Root cause of MSD=IMD (intermodulation distortion).
UL Bands=2, #DL bands=3→Root cause of MSD=IMD (for the 3rd DL bands)

Hence, if there are band combinations consisting of four bands like CA_n1-n3-n78-nX and CA_n1-n3-n78-nY, an example signaling related to the MSD can comprise e.g.

the following information elements:
Parent BC CA_n1-n3-n78-nX
   CA_n1-n3
      MSD: IMD2
      Victim band: n1
   CA_n1-n3
      MSD: cross band isolation
      Victim band: n3
   CA_n1-n78
      MSD: IMD4
      Victim band: n78
   etc.
Parent BC CA_n1-n3-n78-nY
   CA_n1-n3
      MSD: IMD2
      Victim band: n1
   CA_n1-n3
      MSD: cross band isolation
      Victim band: n3
   CA_n1-n78
      MSD: IMD4
      Victim band: n78
   etc.

If the UE supports the above two parent band combinations, exactly the same information is to be reported to the network for both of them. In addition, some fallback band combinations have multiple MSD sources and values. For example, CA_n1-n3-n78 contains the following MSD values as summarized in FIG. 2C. This may require significant overhead, when some of the same information may be transmitted several times (i.e. duplicated), once for each relevant parent band combination.

Moreover, it is likely for one UE to support multiple higher order (i.e. parent) band combinations. For example, band combinations consisting of four bands and including n1, n3, n5, n28 and n78 (or n77) comprise: CA_n1-n3-n5-n78, CA_n1-n3-n7-n78, CA_n1-n3-n8-n77, CA_n1-n3-n8-n78, and CA_n1-n3-n28-n78. Note that band combinations including n77 is listed as well since it is likely for a UE supporting n77 to support n78 as well due to a commonality of the bands in terms of RF components. Also, the listed bands are widely available so that if they are implemented into the UE, all the fallback MSD reporting values are redundantly signaled to a network. It should be noted that in reality, the UE would likely support more higher order band combinations. This problem may become even more critical when a UE capable of low MSD needs to report more information to the network, e.g., by increasing its granularity. Hence, it can be assumed that the number of signaling overhead required for the current way of reporting information related to BCs having low MSD support is significant.

To at least partially tackle this problem, there is proposed a solution for lowering the signaling overhead. In an embodiment, the UE signals only the band combinations for which the lower MSD support is defined, and then the lower MSD support is “inherited” to the parent band combinations for which the signaled BCs are FB BCs. That is, if the FB BC supports lower MSD, then all parent band combinations where the fallback BC is included also support the lower MSD. This kind of “reverse fallback” relation may beneficially allow to have smaller signaling overhead, since UE needs only to signal those (potentially only few) cases where the low MSD is supported. The terms “low MSD” and “lower MSD” are interchangeable through the description. The definition of low MSD may be based on predefined MSD threshold, and/or the threshold value may be based on empirical experimentation and/or statistical simulations, for example. The network may inform the MSD threshold value to the UE(s) over dedicated signaling or via broadcast/multicast, or the MSD threshold value may be predefined by standard specifications.

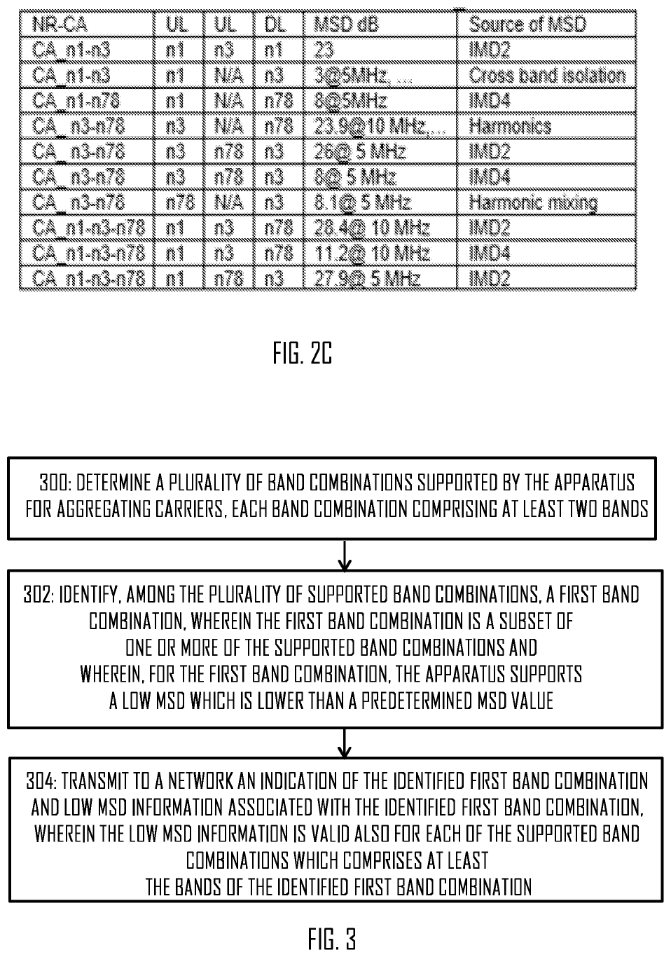

FIG. 3 depicts an example method. The method may be performed by a UE, such as UE 120 of FIG. 1. As shown in FIG. 3, the UE 120, in step 300, determines a plurality of band combinations supported by the UE 120 for aggregating multiple carriers, such as for carrier aggregation (CA) or dual connectivity (DC), i.e. the UE determines supported BCs. Each band combination comprises at least two bands. A “band” comprises a certain range in frequency domain, but as known by a skilled person, the bands are denoted with “nx”, such as n1 or n3, for example. A band combination refers to two or more bands that may be used to establish multiple carriers between the UE and a network, such as the gNB 110.

As an example, the UE may determine it supports bands n1, n3, n5, n7, n28 and n78, and, for aggregating multiple carriers, the UE supports band combinations CA_n1-n3-n5-n78, CA_n1-n3-n7-n78, CA_n1-n3-n28-n78 and CA_n1-n3-n8-n78. To be noted that, for simplicity, these supported BCs for aggregating multiple carriers only list some parent band combinations, and not all subsets of these parent band combinations. In practice the UE supports also the subsets of these parent band combinations.

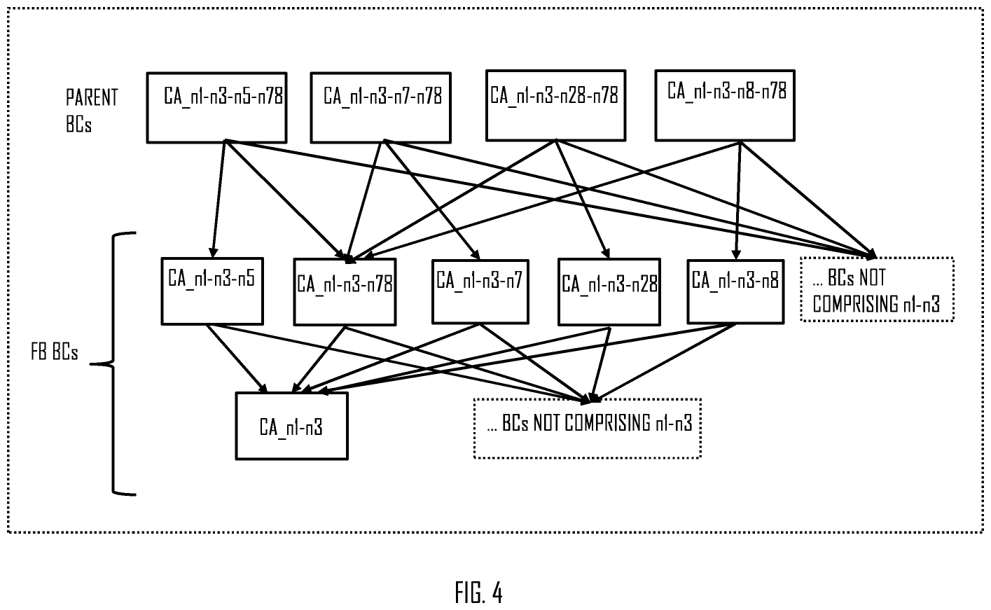

FIG. 4 shows a relationship between parent and example fallback band combinations. The top row of FIG. 4 lists some parent (i.e. higher order) band combinations. The second row comprises fallback BCs which comprise three bands. These fallback BCs are subsets of the parent band combinations. The third (lowest) row comprises fallback combinations comprising only two bands. It may be noted that the BCs on the second row may be seen as parent band combinations for the third row BCs. In the Figure, a fallback relation goes from top to bottom in the Figure. It is to be noted that, in order to keep FIG. 4 simple and readable, that figure does not show all the possible fallback relations.

In an embodiment, the supported BCs for aggregating multiple carriers may comprise the BCs shown in FIG. 4.

In step 302, the UE 120 identifies, among the plurality of supported band combinations, a first band combination. The first BC may in an embodiment be a fallback BC. In another embodiment, the first BC is a parent BC. In the following it is considered that CA_n1-n3 is identified as the first BC. In an embodiment, the first BC is a subset of one or more of the supported BCs.

In an embodiment, when the supported BCs comprise a plurality of different BCs, each comprising e.g. BC n1-n3, and the identified first BC is n1-n3, then the first BC is a subset of each of the supported BCs.

In another embodiment, when the supported BCs comprise a plurality of different BCs such that not all of the supported BCs share a common BC (e.g. CA_n1-n3 is not part of each supported BC), then the identified first BC may be a subset of only one or some of the supported BCs, but not all. One example is shown in FIG. 4 which shows supported BCs for CA, and the determined first BC is CA_n1-n3. It is noted that in FIG. 4 the supported BCs also comprise the BCs on the second row of FIG. 4. However, as can be seen not all of the those BCs comprise CA_n1-n3 as a component.

In general, the first BC is a lower order band combination compared to a parent BC comprising the bands of the first BC.

The identification of the first BC may be based on identifying a BC for which the UE 120 supports a maximum sensitivity degradation (MSD) which is lower than a predetermined MSD value, i.e. the UE supports low MSD for the identified first BC. In an embodiment, the UE may determine all BCs associated with the low MSD based on the predetermined MSD value corresponding to the respective BC, and then select one of those as the first BC. By “supporting” it is meant e.g. that the UE can cope with a lower signal level at signal reception than what is specified on the basis of the predetermined MSD value for that combination and for applied bandwidth. In an embodiment, the predetermined MSD value is or is based on a reference sensitivity degradation value and/or on an applied bandwidth for reception of a downlink signal at the UE. That is, a BC may be identified as low MSD BC when the UE supports, for that BC, MSD lower than specified by the reference sensitivity degradation value. These reference sensitivity degradation values may be dependent on applied bandwidth and these reference sensitivity degradation values may be standardized values, preconfigured to the UE or signaled to the UE by network. FIG. 2A provides an example reference sensitivity degradation values. Different BCs may have different reference sensitivity degradation values. Consequently, if the UE supports, for a band combination CA_n1-n77 of FIG. 2A and for a bandwidth of 40 MHz, an MSD value that is lower than 17.9 dB, then the UE may determine that this BC (CA_n1-n77) is a low/lower MSD BC.

In the example of FIG. 4, the first BC may be CA_n1-n3. It is noted that there are other possible low/lower order BCs obtainable from the high/higher order BCs of FIG. 4, but for simplicity it is considered that those other low order BCs (which do not comprise CA_n1-n3) do not support low MSD and are thus not selectable as the first BC in this example.

In an embodiment, the first BC comprises the smallest number of bands among the supported BCs for which the UE 120 supports the low MSD (i.e. among the supported band combinations which are associated with the low MSD). That is, even if some of the BCs on the second row of FIG. 4 (e.g. CA_n1-n3-n5) are basically selectable as a first BC (since they are subsets of a given supported BC on the top row of FIG. 4), it may be beneficial to select, as the first BC, the BC that comprises the smallest number of bands, i.e. lowest order BC supporting the low MSD, which is CA_n1-n3 in this example. However, in some other embodiments, like for CA_n1-n2-n5-n78, the first BC can be e.g. CA_n1-n5-n78 if that BC has low MSD. That is, a two-band BC is not always the first BC, as the selection of first BC is affected by determination of which BCs are associated with the low MSD.

In step 304 of FIG. 3, the UE 120 transmits to a network, such as to the network node 110, an indication of the identified first BC and low MSD information associated with the identified first BC. The low MSD information may be related to at least one MSD source for the BC, as will be described later.

This low MSD information is considered to be valid also for each of supported BCs which comprises at least the bands of the first BC. Further, the UE 120 supports low MSD for each supported BC which comprises the bands of the first BC. Indicating only the first BC, which comprises the lowest number of bands among the BCs which support low MSD, and the associated low MSD information reduces signaling overhead compared to sending an indication and information separately for each BC that supports low MSD. Sending the indication and the low MSD information only for the first BC is possible because the transmitted indication is interpreted by the network such that the low MSD is also supported for each supported BC which comprises at least the bands of the first BC, and the transmitted low MSD information is interpreted such that the low MSD information is valid (i.e. inherited) also for each supported BC which comprises at least the bands of the first BC.

However, those supported BCs which do not comprise the bands of the first BC are not (necessarily) associated with the low MSD and the low MSD information of the first BC is not valid for those supported BCs which do not comprise the bands of the first BC.

Let us take the example from FIG. 4, where the first BC is considered to be CA_n1-n3. Let us further consider that the UE 120 does not support low MSD for other BCs (such as for CA_n1-n78). In this case, UE signals in step 304 that the lower MSD BC (i.e. the first BC) is CA_n1-n3. This signaling denotes and is interpreted by the network such that the UE 120 also supports the lower MSD for each of the supported BCs where CA_n1-n3 is a component. In FIG. 4, those are the BCs on the top and second row in which CA_n1-n3 is a component.

In an embodiment, in order to accomplish the reduction in signaling overhead, the UE 120 defines information associated with any supported BC that is duplicate information compared to the low MSD information of the first BC that is sent in step 304. For example, it may be that the MSD sources of the first BC (e.g. CA_n1-n3) are the same as for a given supported BC comprising the bands of the first BC (e.g. for CA_n1_n3_n5), in which case the information related to the MSD sources would be duplicate information. The UE 120 may then advantageously refrain from transmitting to the network the duplicated information and assume that the network interprets the low MSD info associated to the fist BC to be valid also for the supported BCs comprising the bands of the first BC. However, if some other non-duplicate information needs to be sent for the supported BC, the UE 120 may transmit that other information to the gNB 110. As an example, if the UE 120 has one MSD source for CA_n1-n3 and another one only for CA_n1-n3-n5, then the UE 120 may transmit separate MSD information for both BCs. The separate information for the CA_n1-n3-n5 may comprise full set of MSD sources or the offset compared to the low MSD information of the first BC (CA_n1-n3).

In an embodiment, the UE determines that the UE 120 is configured or needs to perform low MSD capability reporting to the network (e.g. to gNB 110), wherein the low MSD capability reporting comprises transmitting information related to at least one MSD source for each BC (fallback BC(s) and/or parent BC(s)) for which the apparatus supports the low MSD. In an embodiment, the UE is configured to always indicate the low MSD capability in UE capability reporting. Alternatively, or in addition to, the UE may only indicate the low MSD capability only if requested by the network. In either case, typically, such low MSD capability reporting requires high overhead. However, owing to the proposed solution in FIG. 3, the UE 120 may decide to indicate, as the low MSD capability reporting, only the low MSD information associated with the first BC. This is because the low MSD information is interpreted so that the same information is inherited to each supported BC that comprises at least the first BC. Again, separate low MSD information may still be sent for a given supported BC in case the low MSD information associated to the supported BC comprises some information that is not present in the low MSD information of the first BC.

In an embodiment, the UE 120 determines at least one second BC, among the plurality of supported band combinations, for which the apparatus supports the low MSD. The at least one second BC comprises at least one band different than the bands in the first BC, and any of the at least one second BC is not a subset or a superset of the first BC. Further, any of the second BCs is not a subset of another second BC. Further, each of the at least one second BC is a subset of one or more of the supported BCs. That is, the UE may for example determine further fallback BCs, as the second BCs, than the first BC. As an example, looking at FIG. 4, let us consider that a band combination CA_n1-n28 also supports low MSD. In such case, one of the second BCs can be CA_n1-n28, as this has different bands than the first BC (CA_n1-n3), is not a subset of the first BC (or vice versa) and is a subset one (or more) of the supported BCs, such as of CA_n1-n3-n28-n78.

Consequently, the UE 120 may then transmit to the network an indication of the at least one second BC (e.g. CA_n1-n28) and low MSD information associated with the at least one second BC, wherein the information is valid also for each supported BC which comprises at least the bands of the at least one second BC. For example, the low MSD information of the second BC is valid at least for the supported BCs CA_n1-n3-n28 and CA_n1-n3-n28-n78 of FIG. 4.

However, those supported BCs which do not comprise the bands of the second BC are not (necessarily) associated with the low MSD, and the low MSD information of the second BC is not valid for those supported BCs which do not comprise the bands of the second BC.

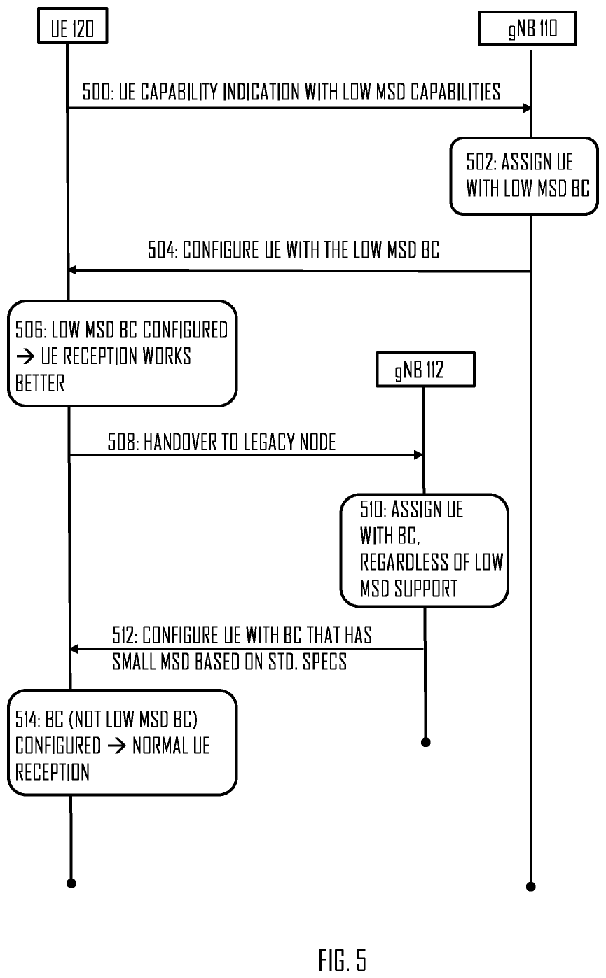

FIG. 5 depicts a signaling flow diagram related to the proposal of FIG. 3. In step 500, the UE 120 performs the low MSD capability reporting. This can be part of general UE capability reporting, for example. The low MSD capability reporting may comprise the indication of the first BC (e.g. CA_n1-n3) and low MSD information associated with the first BC. There may not be a need to indicate duplicate information for the supported BCs because the low MSD information of the first BC is inherited to those supported BCs which comprise at least the bands of the first BC. Similarly, in step 500 the UE 120 may report also low MSD information of any further fallback BCs, such as of the second BC. Again, the UE 120 may refrain from transmitting any duplicate information for those supported BCs which comprise the same bands as in the second BC.

Step 500 may also comprise, in an embodiment, the UE transmitting to the gNB 110 an indication of the plurality of band combinations supported by the UE for aggregating multiple carriers (i.e. indicate the supported BCs). That is, the UE may in the example embodiment of FIG. 4 signal that the supported BCs comprise e.g. CA_n1-n3-n5-n78, CA_n1-n3-n7-n78, CA_n1-n3-n28-n78 and CA_n1-n3-n8-n78. In an embodiment the UE 120 indicates only supersets which the UE supports as BCs, and all subsets of the supersets would be considered as supported BCs as well. It is noted that the UE may support other BCs as well, and these may be indicated to the network as well.

In step 502, the gNB 110 may assign/configure the UE 120 with a band combination that supports the low MSD. This assignment may be based on the received indication of the first and possibly at least one second BC, and on the low MSD information associated to any of those. The low MSD information may e.g. indicate for each indicated BC at least one MSD source for which UE 120 supports the low MSD in connection of the respective BC. The network's behaviour may become different based on the MSD source indications. For example, if the 2^{nd} harmonic is the indicated MSD source for the assigned BC, the network may adjust the position of uplink resource blocks (RBs) and its number and that of downlink RBs, in order for the UL RB frequency not to be equal to the position of DL RBs. As another example, if cross band isolation is the indicated MSD source for the configured BC, the UL RBs are beneficially set to be away from the victim channel bandwidth and/or DL RBs are set away from the aggressor channel bandwidth, if possible.

In step 504, the gNB 110 configures the UE 120 with the assigned low MSD BC. In this manner the network may better utilize the capabilities of the UE, as compared to assigning the UE with some other BC that is not necessarily a low MSD BC (i.e. a BC for which the UE support MSD lower than specified e.g. by reference sensitivity values). In step 506, the UE applies the configured BC for aggregating multiple carriers. This may beneficially improve the UE's signal reception.

In step 508, the UE moves to another cell which may be provided by a legacy node (e.g. node 112), not configured to understand the low MSD capability reporting. The UE 120 may or may not send the low capability reporting to the new node 112. The node 112 may in step 510 assign the UE with a BC that has small MSD based on standard specifications (see FIG. 2A, for example), i.e. without considering what would be low MSD BC for this particular UE. In step 512, the node 112 may configure the UE with such BC, and in step 514 the UE may utilize the BC in aggregating multiple carriers.

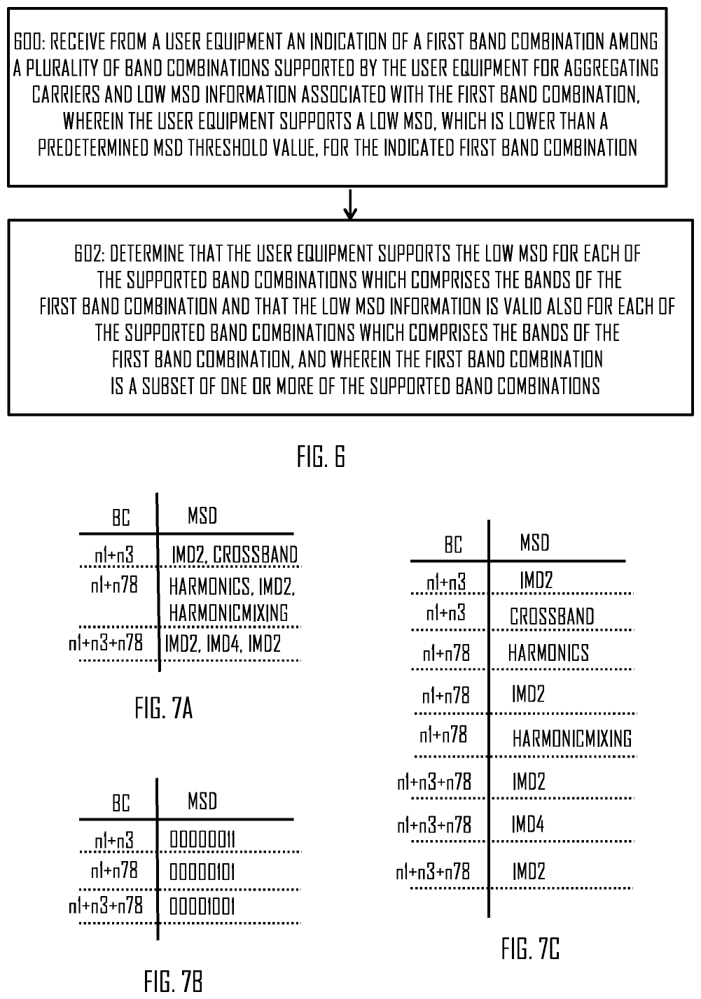

FIG. 6 depicts an example method from network point of view. The method may be performed by a network node, such as the gNB 110 of FIG. 1. In step 600, the gNB 110 receives from the UE 120 an indication of the first BC among a plurality of BCs supported by the UE 120 and low MSD information associated with the first BC, wherein the UE supports the low MSD for the indicated first BC. In step 602 the gNB 110 determines that the UE supports the low MSD for each of the supported BCs which comprises the bands of the indicated first BC and that the low MSD information is valid also for each supported BC which comprises the bands of the indicated first BC.

The provided embodiments may thus enable the UE 120 to determine what is/are the minimum unit of band combination(s) (e.g. the first BC, e.g. CA_n1-n3, and possibly second BCs, e.g. CA_n1-n28) which is associated with lower MSD value due to a certain at least one MSD source. The UE may then report, as the low MSD capability reporting, the low MSD information of only these BCs. The low MSD information sets of these BCs (CA_n1-n3 and CA_n1-n28) may then be, by the network, inherited to any band combination supported by the UE and including the indicated BCs, respectively. E.g. the low MSD information associated with CA_n1_n3 is inherited to each UE supported BC comprising bands n1 and n3, and the low MSD information associated with CA_n1_n28 is inherited to each UE supported BC comprising bands n1 and n28.

In an embodiment, the low MSD information associated with the indicted first and/or with the indicated second BC indicates at least one MSD source for which UE 120 supports the low MSD in connection of the respective BC. Let us now take a look at how the low MSD information indicating the at least one MSD source can be signaled to the network according to different embodiments.

In an embodiment, each of the at least one MSD source is indicated explicitly for the respective band combination, e.g. in radio resource control (RRC) signaling. In this example, one low MSD BC entry indicates multiple MSD sources for which the UE 120 supports lower MSD than otherwise specified (e.g. in standard specifications). The signaling can be organized so that there is a single code point for each MSD source as shown in the example below. This embodiment may provide a simple signaling solution because the MSD causes are included directly in RRC signaling, and can be easily extended later on.

MSD-Capability information element

-- ASN1START
-- TAG-MSD-CAPABILITY-START
MSD-Capability-r17 ::= SEQUENCE {

| | |
|---|---|
| imd2 | ENUMERATED {true} OPTIONAL, |
| imd3 | ENUMERATED {true} OPTIONAL, |
| imd4 | ENUMERATED {true} OPTIONAL, |
| imd5 | ENUMERATED {true} OPTIONAL, |
| harmonics | ENUMERATED {true} OPTIONAL, |
| harmonicMixing | ENUMERATED {true} OPTIONAL, |
| crossBandIsolation | ENUMERATED {true} OPTIONAL, |

...
}
-- TAG-MSD-CAPABILITY-STOP
-- ASN1STOP

Related to the above example, term “imdx” indicates that UE supports lower MSD when the source of MSD is IMDX (where X=2, 3, 4 or 5). Term “harmonics” indicates that UE supports lower MSD when the source of MSD is harmonics. Term “harmonicMixing” indicates that UE supports lower MSD when the source of MSD is harmonic mixing, as defined in TS38.101-1. Term “crossBandIsolation” indicates that UE supports lower MSD when the source of MSD is cross-band isolation.

In another embodiment, each of the at least one MSD source is indicated via respective index in a bit string for the respective band combination. That is, this embodiment uses a bit string whose bit positions may be e.g. defined in standard specifications. In this example, one low MSD BC entry indicates multiple MSD sources for which the UE supports lower MSD than currently specified. The signaling may be organized so that there is a bit string/vector defined in standard specifications. This alternative may apply fixed size, so it may be size-efficient in case multiple values are indicated, and its overhead is constant.

Below shows one example for some example band combinations of how the bit string could be defined in standard specifications. Here the IE MSD-Capability indicates the types of applicable lower MSD requirements. The MSD sources may be represented as a BIT STRING and the definition of each bit may be defined in below tables, which merely show some examples. The value “8” was also chosen as an example here.

### MSD-Capability Information Element

ASN1START
TAG-MSD-CAPABILITY-START
MSD-Capability-r17::=BIT STRING (SIZE (maxMSD-Causes-r17)) maxMSD-Causes-r17 INTEGER::=8—Maximum number of MSD causes per BC
TAG-MSD-CAPABILITY-STOP
ASN1STOP

TABLE 1
BIT STRING positions for Low MSDs defined in CA_n1-n3

| Index | NR-CA | UL | UL | DL | MSD dB | Source of MSD |
|---|---|---|---|---|---|---|
| 0 | CA_n1-n3 | n1 | n3 | n1 | 23 | IMD2 |
| 1 | CA_n1-n3 | n1 | N/A | n3 | 3@5 MHz, . . . | Cross band |
| | | | | | | isolation |

TABLE 2
BIT STRING positions for Low MSDs defined in CA_n3-78

| Index | NR-CA | UL | UL | DL | MSD dB | Source of MSD |
|---|---|---|---|---|---|---|
| 0 | CA_n3-n78 | n3 | N/A | n78 | 23.9@10 MHz, . . . | Harmonics |
| 1 | CA_n3-n78 | n3 | n78 | n3 | 26@ 5 MHz | IMD2 |
| 2 | CA_n3-n78 | n78 | N/A | n3 | 8.1@ 5 MHz | Harmonic mixing |

TABLE 3
BIT STRING positions for Low MSDs defined in CA_n1-n3-78

| | | | | | | Source |
|---|---|---|---|---|---|---|
| Index | NR-CA | UL | UL | DL | MSD dB | of MSD |
| 0 | CA_n1-n3-n78 | n1 | n3 | n78 | 28.4@ 10 MHz | IMD2 |
| 1 | CA_n1-n3-n78 | n1 | n3 | n78 | 11.2@ 10 MHz | IMD4 |
| 2 | CA_n1-n3-n78 | n1 | n78 | n3 | 27.9@ 5 MHz | IMD2 |

In yet one embodiment, a single MSD source among the at least one MSD source is indicated for the respective band combination. In this example, one low MSD BC entry only indicates one MSD source for which the UE 120 can do lower MSD than currently specified. If UE supports multiple lower MSD sources, then the signaling BC can be repeated as the same BC with different MSD type. The signaling may be organized so that there is a single MSD type which a BC can refer to. An example may be as follows:

### MSD-Capability Information Element

ASN1START
TAG-MSD-CAPABILITY-START
MSD-Capability-r17::=ENUMERATED {imd2, imd3, imd4, imd5, harmonics, harmonicMixing, crossBandIsolation, . . . }
TAG-MSD-CAPABILITY-STOP
ASN1STOP

FIG. 7A-7C show some differences between these three alternatives for signaling, in one example scenario. FIG. 7A depicts the signaling where the lower MSD capabilities are explicitly listed in RRC. FIG. 7B illustrates the signaling solution utilizing the bit string. FIG. 7C shows the signaling where single MSD capability for the low MSD BC is indicated, with multiple causes requiring multiple BC entries.

An embodiment, as shown in FIG. 8, provides an apparatus 10 comprising a control circuitry (CTRL) 12, such as at least one processor, and at least one memory 14 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 10 may comprise the terminal device of a communication system, e.g. a user terminal (UT), a computer (PC), a laptop, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 10 is or is comprised in the UE 120. The apparatus may be caused to execute some of the functionalities of the above described processes, such as the steps of FIGS. 3 and 5, for example.

The apparatus may further comprise a radio interface (TRX) 16 comprising hardware and/or software for realizing communication connectivity according to one or more communication protocols. The TRX may provide the apparatus with communication capabilities to access the radio access network, for example.

The apparatus may also comprise a user interface 18 comprising, for example, at least one keypad, a microphone, a touch display, a display, a speaker, etc. The user interface may be used to control the apparatus by the user.

The control circuitry 12 may comprise a supported band combination determination circuitry 20 for determining which band combinations are supported by the apparatus for aggregating multiple carriers (such as for DC or CA), according to any of the embodiments. The control circuitry 12 may further comprise a low MSD BC determination circuitry 22 for determining the first and possibly at least one second BC fulfilling the low MSD criteria, according to any of the embodiments.

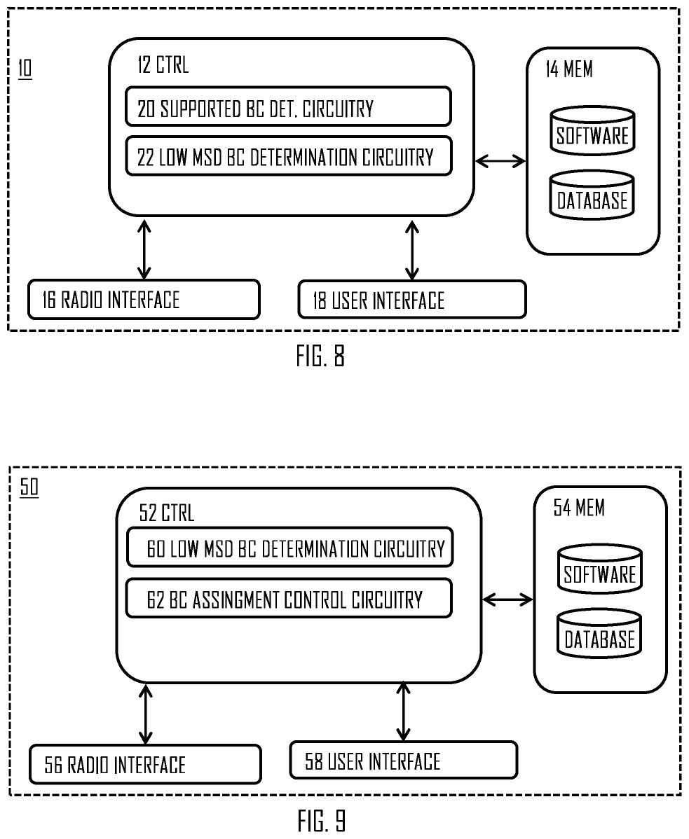

An embodiment, as shown in FIG. 9, provides an apparatus 50 comprising a control circuitry (CTRL) 52, such as at least one processor, and at least one memory 54 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 50 may be or be comprised in a network node, such as in gNB/gNB-CU/gNB-DU of 5G. In an embodiment, the apparatus is or is comprised in the network node 110. The apparatus may be caused to execute some of the functionalities of the above described processes, such as the steps of FIGS. 5 and 6, for example.

In an embodiment, a CU-DU (central unit-distributed unit) architecture is implemented. In such case the apparatus 50 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the radio node may be stand-alone apparatuses communicating with each other via a radio path or via a wired connection. Alternatively, they may be in a same entity communicating via a wired connection, etc. The edge cloud or edge cloud server may serve a plurality of radio nodes or a radio access networks. In an embodiment, at least some of the described processes may be performed by the central unit. In another embodiment, the apparatus may be instead comprised in the distributed unit, and at least some of the described processes may be performed by the distributed unit. In an embodiment, the execution of at least some of the functionalities of the apparatus 50 may be shared between two physically separate devices (DU and CU) forming one operational entity. Therefore, the apparatus may be seen to depict the operational entity comprising one or more physically separate devices for executing at least some of the described processes. In an embodiment, the apparatus controls the execution of the processes, regardless of the location of the apparatus and regardless of where the processes/functions are carried out.

The apparatus may further comprise communication interface (TRX) 56 comprising hardware and/or software for realizing communication connectivity according to one or more communication protocols. The TRX may provide the apparatus with communication capabilities to access the radio access net-work, for example. The apparatus may also comprise a user interface 58 comprising, for example, at least one keypad, a microphone, a touch display, a display, a speaker, etc. The user interface may be used to control the apparatus by the user.

The control circuitry 52 may comprise a low MSD BC determination circuitry 60 for determining which BCs supported by the UE are low MSD BCs. This may be based on e.g. indication of the first and possibly at least one second BC, and/or the low MSD capability reporting from the UE, for example. The control circuitry 52 may comprise a BC assignment control circuitry 62 e.g. for assigning a low MSD BC to the UE, according to any of the embodiments.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Following is a list of some aspects of the invention.

According to a first aspect, there is provided a method, comprising: determining a plurality of band combinations supported by a user equipment for aggregating multiple carriers, each band combination comprising at least two bands; identifying, among the plurality of supported band combinations, a first band combination, wherein the first band combination is a subset of one or more of the supported band combinations and wherein, for the first band combination, the user equipment supports a low maximum sensitivity degradation (MSD) which is lower than a predetermined MSD value; and transmitting to a network an indication of the identified first band combination and low MSD information associated with the identified first band combination, wherein the low MSD information is valid also for each of the supported band combinations which comprises at least the bands of the first band combination.

Various embodiments of the first aspect may comprise at least one feature from the following bulleted list:
wherein the user equipment supports the low MSD for each of the supported band combinations which comprises the bands of the first band combination.
wherein the transmitted indication is interpreted by the network such that the low MSD is also supported for each of the supported band combinations which comprises at least the bands of the first band combination, and the transmitted low MSD information is interpreted such that the low MSD information is valid also for each of the supported band combinations which comprises at least the bands of the first band combination.
determining low MSD information associated with any of the supported band combinations that is duplicate information compared to the low MSD information of the first band combination; and refraining from transmitting to the network the duplicate information.
determining that the user equipment is configured to perform low MSD capability reporting to the network, wherein the low MSD capability reporting comprises transmitting low MSD information for each band combination for which the apparatus supports the low MSD; and deciding to indicate, as the low MSD capability reporting, only the low MSD information associated with the first band combination.
wherein the first band combination is the band combination that comprises the smallest number of bands among the supported band combinations which are associated with the low MSD.
transmitting to the network an indication of the plurality of band combinations supported by the user equipment for aggregating multiple carriers.
determining at least one second band combination, among the plurality of supported band combinations, for which the user equipment supports the low MSD, wherein the at least one second band combination comprises at least one band different than the bands in the first band combination, wherein the first band combination is not a subset of any of the at least one second band combination and wherein each of the at least one second band combination is a subset of one or more of the supported band combinations; and transmitting to the network an indication of the at least one second band combination and low MSD information associated with the at least one second band combination, wherein the low MSD information is valid also for each supported band combination which comprises at least the bands of the at least one second band combination.
wherein the low MSD information associated with a band combination indicates at least one MSD source for which user equipment supports the low MSD in connection of the respective band combination.
wherein each of the at least one MSD source is indicated explicitly for the respective band combination.
wherein each of the at least one MSD source is indicated via respective index in a bit string for the respective band combination.
wherein a single MSD source among the at least one MSD source is indicated for the respective band combination.
wherein the predetermined MSD value is based on a reference sensitivity degradation values and on an applied bandwidth for reception of a downlink signal at the user equipment.

According to a second aspect, there is provided a method, comprising: receiving by a network node from a user equipment an indication of a first band combination among a plurality of band combinations supported by the user equipment for aggregating multiple carriers and low MSD information associated with the first band combination, wherein the user equipment supports a low maximum sensitivity degradation (MSD), which is lower than a predetermined MSD threshold value, for the indicated first band combination; and determining that the user equipment supports the low MSD for each of the supported band combinations which comprises the bands of the indicated first band combination and that the low MSD information is valid also for each of the supported band combinations which comprises the bands of the indicated first band combination, and wherein the first band combination is a subset of one or more of the supported band combinations.

Various embodiments of the second aspect may comprise at least one feature from the following bulleted list:
receive an indication of the plurality of band combinations supported by the user equipment for aggregating multiple carriers, each band combination comprising at least two bands.
wherein the low MSD information indicates at least one MSD source for which the user equipment supports the low MSD in connection of the first band combination.
configuring the user equipment with a band combination that is associated with the low MSD.

According to a third aspect, there is provided an apparatus, comprising: at least one processor and at least one memory storing instructions that, when executed by the at least one processor, cause the apparatus at least to: determine a plurality of band combinations supported by the apparatus for aggregating multiple carriers, each band combination comprising at least two bands; identify, among the plurality of supported band combinations, a first band combination, wherein the first band combination is a subset of one or more of the supported band combinations and wherein, for the first band combination, the apparatus supports a low maximum sensitivity degradation (MSD) which is lower than a predetermined MSD value; and transmit to a network an indication of the identified first band combination and low MSD information associated with the identified first band combination, wherein the low MSD information is valid also for each of the supported band combinations which comprises at least the bands of the first band combination. Various embodiments of the third aspect may comprise at least one feature from the bulleted list under the first aspect.

According to a fourth aspect, there is provided an apparatus, comprising: at least one processor and at least one memory storing instructions that, when executed by the at least one processor, cause the apparatus at least to: receive from a user equipment an indication of a first band combination among a plurality of band combinations supported by the user equipment for aggregating multiple carriers and low MSD information associated with the first band combination, wherein the user equipment supports a low maximum sensitivity degradation (MSD), which is lower than a predetermined MSD threshold value, for the indicated first band combination; and determine that the user equipment supports the low MSD for each of the supported band combinations which comprises the bands of the indicated first band combination and that the low MSD information is valid also for each of the supported band combinations which comprises the bands of the indicated first band combination, and wherein the first band combination is a subset of one or more of the supported band combinations. Various embodiments of the fourth aspect may comprise at least one feature from the bulleted list under the second aspect.

According to a fifth aspect, there is provided a computer program product embodied on a distribution medium readable by a computer and comprising program instructions which, when loaded into an apparatus, execute the method according to the first aspect.

According to a sixth aspect, there is provided a computer program product embodied on a distribution medium readable by a computer and comprising program instructions which, when loaded into an apparatus, execute the method according to the second aspect.

According to a seventh aspect, there is provided a computer program product comprising program instructions which, when loaded into an apparatus, execute the method according to the first aspect.

According to an eight aspect, there is provided a computer program product comprising program instructions which, when loaded into an apparatus, execute the method according to the second aspect.

According to a ninth aspect, there is provided an apparatus, comprising means for performing the method according to the first aspect, and/or means configured to cause the apparatus to perform the method according to the first aspect.

According to a tenth aspect, there is provided an apparatus, comprising means for performing the method according to the second aspect, and/or means configured to cause the apparatus to perform the method according to the second aspect.

According to an eleventh aspect, there is provided computer system, comprising: one or more processors; at least one data storage, and one or more computer program instructions to be executed by the one or more processors in association with the at least one data storage for carrying out the method according to the first aspect and/or the method according to the second aspect.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor and at least one memory storing instructions that, when executed by the at least one processor, cause the apparatus at least to:
determine a plurality of band combinations supported by the apparatus for aggregating multiple carriers, each band combination comprising at least two bands;
identify, among the plurality of supported band combinations, a first band combination, wherein the first band combination is a subset of one or more of the supported band combinations and wherein, for the first band combination, the apparatus supports a low maximum sensitivity degradation (MSD) which is lower than a predetermined MSD value; and
transmit to a network an indication of the identified first band combination and low MSD information associated with the identified first band combination, wherein the low MSD information is valid also for each of the supported band combinations which comprises at least the bands of the first band combination.

2. The apparatus of claim 1, wherein the apparatus supports the low MSD for each of the supported band combinations which comprises the bands of the first band combination.

3. The apparatus of claim 1, wherein the transmitted indication is interpreted by the network such that the low MSD is also supported for each of the supported band combinations which comprises at least the bands of the first band combination, and the transmitted low MSD information is interpreted such that the low MSD information is valid also for each of the supported band combinations which comprises at least the bands of the first band combination.

4. The apparatus of claim 1, wherein the at least one memory and the instructions are configured, with the at least one processor, to cause the apparatus further to:
determine low MSD information associated with any of the supported band combinations that is duplicate information compared to the low MSD information of the first band combination; and
refrain from transmitting to the network the duplicate information.

5. The apparatus of claim 1, wherein the instructions, when executed by the at least one processor, cause the apparatus further to:
determine that the apparatus is configured to perform low MSD capability reporting to the network, wherein the low MSD capability reporting comprises transmitting low MSD information for each band combination for which the apparatus supports the low MSD; and
decide to indicate, as the low MSD capability reporting, only the low MSD information associated with the first band combination.

6. The apparatus of claim 1, wherein the first band combination is the band combination that comprises the smallest number of bands among the supported band combinations which are associated with the low MSD.

7. The apparatus of claim 1, wherein the at least one memory and the instructions are configured, with the at least one processor, to cause the apparatus further to:
transmit to the network an indication of the plurality of band combinations supported by the apparatus for aggregating multiple carriers.

8. The apparatus of claim 1, wherein the instructions, when executed by the at least one processor, cause the apparatus further to:
determine at least one second band combination, among the plurality of supported band combinations, for which the apparatus supports the low MSD, wherein the at least one second band combination comprises at least one band different than the bands in the first band combination, wherein the first band combination is not a subset of any of the at least one second band combination and wherein each of the at least one second band combination is a subset of one or more of the supported band combinations; and
transmit to the network an indication of the at least one second band combination and low MSD information associated with the at least one second band combination, wherein the low MSD information is valid also for each supported band combination which comprises at least the bands of the at least one second band combination.

9. The apparatus of claim 1, wherein the low MSD information associated with a band combination indicates at least one MSD source for which apparatus supports the low MSD in connection of the respective band combination.

10. The apparatus of claim 9, wherein each of the at least one MSD source is indicated explicitly for the respective band combination.

11. The apparatus of claim 9, wherein each of the at least one MSD source is indicated via respective index in a bit string for the respective band combination.

12. The apparatus of claim 9, wherein a single MSD source among the at least one MSD source is indicated for the respective band combination.

13. The apparatus of claim 1, wherein the predetermined MSD value is based on a reference sensitivity degradation values and on an applied bandwidth for reception of a downlink signal at the apparatus.

14. The apparatus of claim 1, wherein the apparatus is or is comprised in a user equipment and the apparatus is operating according to the long term evolution, according to the long term evolution advanced, or according to New Radio.

15. An apparatus, comprising:
at least one processor and at least one memory storing instructions that, when executed by the at least one processor, cause the apparatus at least to:
receive from a user equipment an indication of a first band combination among a plurality of band combinations supported by the user equipment for aggregating multiple carriers and low MSD information associated with the first band combination, wherein the user equipment supports a low maximum sensitivity degradation (MSD), which is lower than a predetermined MSD threshold value, for the indicated first band combination; and
determine that the user equipment supports the low MSD for each of the supported band combinations which comprises the bands of the indicated first band combination and that the low MSD information is valid also for each of the supported band combinations which comprises the bands of the indicated first band combination, and wherein the first band combination is a subset of one or more of the supported band combinations.

16. The apparatus of claim 15, wherein the instructions, when executed by the at least one processor, cause the apparatus further to:
receive an indication of the plurality of band combinations supported by the user equipment for aggregating multiple carriers, each band combination comprising at least two bands.

17. The apparatus of claim 15, wherein the low MSD information indicates at least one MSD source for which the user equipment supports the low MSD in connection of the first band combination.

18. The apparatus of claim 15, wherein the instructions, when executed by the at least one processor, cause the apparatus further to:
configure the user equipment with a band combination that is associated with the low MSD.

19. A method performed by a user equipment, the method comprising:
determining a plurality of band combinations supported by the user equipment for aggregating multiple carriers, each band combination comprising at least two bands;
identifying, among the plurality of supported band combinations, a first band combination wherein the first band combination is a subset of one or more of the supported band combinations and wherein, for the first band combination, the user equipment supports a low maximum sensitivity degradation (MSD) which is lower than a predetermined MSD value; and
transmitting to a network an indication of the identified first band combination and low MSD information associated with the identified first band combination, wherein the low MSD information is valid also for each of the supported band combinations which comprises at least the bands of the first band combination.

20-23. (canceled)
